(19) United States
(12) Patent Application Publication
(10) Pub. No.: US 2025/0027442 A1
(43) Pub. Date: Jan. 23, 2025

(54) AUTOMATED FLUSHING SYSTEM

(71) Applicant: Reverso Pumps, LLC, Fort Lauderdale, FL (US)

(72) Inventors: Michael Docy, Cleveland, OH (US); Robert McGinley, Cleveland, OH (US); Patrick Bauman, Highland Heights, OH (US); Richard Lyew, Parkland, FL (US)

(21) Appl. No.: 18/778,431

(22) Filed: Jul. 19, 2024

Related U.S. Application Data
(60) Provisional application No. 63/514,486, filed on Jul. 19, 2023.

(51) Int. Cl. F02B 77/04; F02B 61/04

(52) U.S. Cl. CPC F02B 77/04; F02B 61/045; F02B 2077/045

(57) ABSTRACT

An example of a flushing system includes an inlet port, a flow manifold, and a plurality of outlet ports. An inlet channel is formed by a main body of the flow manifold and is connected to the inlet port. A plurality of outlet channels connect to the inlet channel and to a plurality of outlet valves that are also connected to the outlet ports. A controller is configured to control actuators attached to the outlet valves to actuate each of the outlet valves to permit water to flow from the inlet port to each of the outlet ports.

### CROSS-REFERENCE TO RELATED APPLICATIONS

The present application claims the benefit of U.S. Provisional Application Ser. No. 63/514,486, filed on Jul. 19, 2023, entitled AUTOMATED FLUSHING SYSTEM, the entire disclosure of which is incorporated herein by reference in its entirety.

### TECHNICAL FIELD

The present application relates generally to devices for maintaining boat motors and in particular to systems for flushing salt water from one or more motors, such as marine outboard motors.

### BACKGROUND

Heat generated during the operation of an internal combustion engine is transferred away from the engine to prevent damage to the engine components. Typically, a heat transfer fluid is pumped through the engine to remove heat from the engine. The heated fluid is then cooled in a radiator or other cooling system before being pumped back into the engine. Rather than cool and recirculate the cooling fluid, a cooling system for a motor on a boat draws in water from the body of water in which the boat is operated for use as a heat transfer fluid. After passing through and being heated by the motor, the heated water is discharged back to the body of water that it was drawn from.

To prevent damage to the motor from foreign objects in the water drawn into the motor for cooling, an intake filter is typically installed on the water intake. These filters are typically insufficient to remove salt, other minerals, and impurities dissolved in the water. Residue from these impurities can build up over time and restrict flow through or otherwise damage the cooling system of the motor. Motor manufacturers recommend flushing fresh water through the cooling system regularly to prevent the impurities from building up. Like many maintenance tasks, manually flushing each of one or more motors of a boat is time consuming, tedious, and can end up being neglected.

### SUMMARY

Exemplary embodiments of flushing systems, methods of operating a flushing system, and methods of forming flushing systems are disclosed herein.

An example of a flushing system includes: an inlet port; an inlet channel in fluid communication with the inlet port, the inlet channel being formed by a main body of a flow manifold; a plurality of outlet channels in fluid communication with the inlet channel and a plurality of outlet valves, wherein each outlet valve comprises a valve inlet that is connected to an outlet interface of the main body of the flow manifold, and wherein the valve inlet comprises a plurality of O-ring seals for forming a water-tight connection between the valve inlet and the outlet interface; a plurality of outlet ports, each outlet port in fluid communication with one of the plurality of outlet valves; an actuator attached to each of the plurality of outlet valves; and a controller configured to control each of the actuators to actuate each of the outlet valves to permit water to flow from the inlet port to each of the outlet ports.

An example of a method of operating a flushing system includes steps of: opening one of two or more outlet valves; waiting for a predetermined cycle time; closing the outlet valve after the predetermined cycle time has expired; and repeating the steps of opening, waiting, and closing for each of the two or more outlet valves. The flushing system including an inlet port, two or more outlet ports, an inlet channel in fluid communication with the inlet port, two or more outlet channels in fluid communication with the inlet channel and the two or more outlet ports, and an outlet valve provided in each of the two or more outlet channels.

A further understanding of the nature and advantages of the present invention are set forth in the following description and claims, particularly when considered in conjunction with the accompanying drawings in which like parts bear like reference numerals.

### BRIEF DESCRIPTION OF THE DRAWINGS

To further clarify various aspects of embodiments of the present disclosure, a more particular description of the certain embodiments will be made by reference to various aspects of the appended drawings. It is appreciated that these drawings depict only typical embodiments of the present disclosure and are therefore not to be considered limiting of the scope of the disclosure. Moreover, while the figures can be drawn to scale for some embodiments, the figures are not necessarily drawn to scale for all embodiments. Embodiments and other features and advantages of the present disclosure will be described and explained with additional specificity and detail through the use of the accompanying drawings in which:

FIG. 1 is an illustration of a boat including an example of a flushing system described herein;

FIG. 2 shows a perspective view of an example of a flushing system described herein;

FIG. 3 shows an exploded view thereof;

FIG. 4 shows an exploded view of the fluid components thereof;

FIG. 5 shows a side view thereof;

FIG. 6 shows a front view thereof;

FIG. 7 shows a cross-sectional view of the flushing system of FIG. 5, taken along the line A-A;

FIG. 8 shows an enlarged detail view of the area C of FIG. 8;

FIG. 9 shows a cross-sectional view of the flushing system of FIG. 6 with four outlet valves, taken along the line B-B;

FIG. 10 shows a cross-sectional view of the flushing system of FIG. 6 with two outlet valves, taken along the line B-B;

FIG. 11 shows a block diagram of the control system of an exemplary flushing system;

FIG. 12 is a flow diagram that illustrates an exemplary methodology for operating an exemplary flushing system;

FIG. 13 is a flow diagram that illustrates an exemplary methodology for making an exemplary flushing system;

FIG. 14 is a cross-sectional view of a pilot-operated outlet valve in a closed condition;

FIG. 15 is a cross-sectional view of a pilot-operated outlet valve in an open condition;

FIG. 16 is an illustration of a boat connected to an example of a flushing system described herein, the flushing system being attached to an adjacent dock; and

FIG. 17 is an illustration of a boat including an example of a flushing system described herein, the flushing system being connected to another flushing system attached to an adjacent dock.

### DETAILED DESCRIPTION

The following description refers to the accompanying drawings, which illustrate specific embodiments of the present disclosure. Other embodiments having different structures and operation do not depart from the scope of the present disclosure.

Various technologies pertaining to flushing systems for marine motors and methods for operating and making the same are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

Additionally, when one or more components are described as being connected, joined, affixed, coupled, attached, or otherwise interconnected, such interconnection may be direct as between the components or may be indirect such as through the use of one or more intermediary components. Also as described herein, reference to a “member,” “component,” or “portion” shall not be limited to a single structural member, component, or element but can include an assembly of components, members, or elements. Also as described herein, the terms “substantially” and “about” are defined as at least close to (and includes) a given value or state.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Numerical values or ranges stated herein are understood to encompass values at or near the stated value and/or above or below the stated range. For this application, the stated value can encompass plus or minus 5% of the value and the stated range can encompass plus or minus 5% of the extent of the range. In addition, the stated value or range can include a margin of error for the value or range typical in the art for the property being measured. The stated value or range can also encompass those values and ranges that would be considered equivalent to the stated value or range by one of ordinary skill in the art. As an example, a temperature expressed as a range of 100 degrees to 200 degrees Fahrenheit is understood to include temperatures above and below the ends of the range by 5% of the extent of the 100-degree range—e.g., 95 degrees to 205 degrees Fahrenheit. As another example, the pressure of a fluid expressed as a value of 20 pounds per square inch includes values above and below 20 pounds per square inch that are within the margin of error of a tool typically used to measure pressures of that magnitude. As yet another example, a time duration expressed as a value of 2 minutes seconds includes values above and below 2 minutes that would be considered equivalent by one of ordinary skill in the art.

Further, as used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices. Additionally, as used herein, the term “exemplary” is intended to mean serving as an illustration or example of something and is not intended to indicate a preference.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

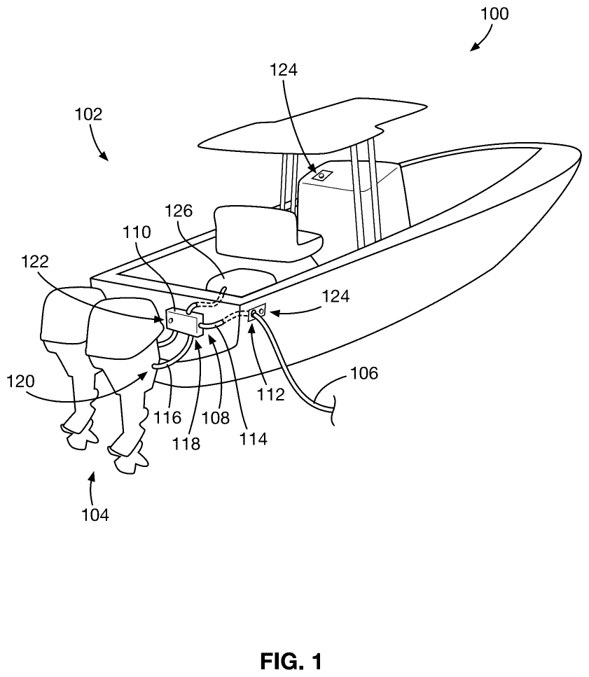

Referring now to FIG. 1, a boat 100 is shown that includes an exemplary automatic flushing system 102. The boat 100 includes one or more motors 104 that can be arranged outboard, as shown, or inboard of the hull of the boat 100. The flushing system 102 is supplied with water from a supply hose 106 providing fresh, clean water from a water supply (not shown) such as a municipal water system. The supply hose 106 can be attached to an inlet port 108 of a distribution manifold 110 or can be attached via an optional remote inlet port 112 arranged on an exterior of the boat 100 for more convenient access to the flushing system 102. When the supply hose 106 is attached to the remote inlet port 112, an inlet hose 114 provides a fluid connection between the remote inlet port 112 and the inlet port 108 of the distribution manifold 110. The inlet hose 114 can also be connected to a fresh water tank (not shown) on the boat 100 so that the flushing system 102 can operate when the boat 100 is at sea. The inlet hose 114 can include a valve (not shown) for selecting the source of water, either from the supply hose 106 or the fresh water tank. The same valve can be used to direct fresh water from the supply hose 106 into the fresh water tank to fill the tank while the boat 100 is docked. One or more outlet hoses 116 fluidly connect to one or more outlet ports 118 of the distribution manifold 110 and a flushing port 120 of each of the one or more motors 104 of the boat 100.

When the boat 100 has been docked after use, the supply hose 106 is connected to the inlet port 108 or the remote inlet port 112 to supply water to the distribution manifold 110. After water has been provided via the supply hose 106, the flushing system 102 can be activated by manipulating a local button or switch 122 on the distribution manifold 110 or a remote button or switch 124 installed elsewhere on the boat 100, for example, near the remote inlet port 112 or other controls for the boat 100. The flushing system 102 can optionally include a sensor for detecting the presence of water at the inlet port 108 so that the flushing system 102 does not operate when no water has been provided at the inlet port 108.

Once activated, the flushing system 102 distributes water from the supply hose 106 to each of the one or more outlet hoses 116 to flush fresh water through the cooling system of each of the one or more motors 104 to remove debris and to prohibit the accumulation of salt from the salt water used to cool the motor 104 during operation of the boat 100. That is, the flushing system 102 provides a user with one place to attach a source of water and one button to push so that the user has a single interaction point to direct cleansing water to one or more motors 104 of the boat 100. Additional distribution manifolds 110 can be combined with an inlet manifold (not shown) or additional supply hoses (not shown) to automatically provide fresh water for flushing additional motors, motors with more than one flushing port, or a non-motor cooling system 126 of the boat 100 that requires regular cleaning with fresh water. For example, the non-motor cooling system 126 can be part of a gyroscopic stabilization system (e.g., a Seakeeper system) or a marine air conditioning system for boats with closed cabins. Gyroscopic stabilization systems can be cooled with a water-cooling system that draws in seawater to cool the components and marine air conditioners similarly use seawater to cool the refrigerant in the refrigeration cycle. These cooling systems require regular flushing after use to prohibit the accumulation of salt or other contaminants. While the flushing system 102 has been described as being used to flush cooling systems, the flushing system 102 and other flushing systems described herein can also be used to flush fresh water through any kind of seawater-based system, such as, for example, a water making system.

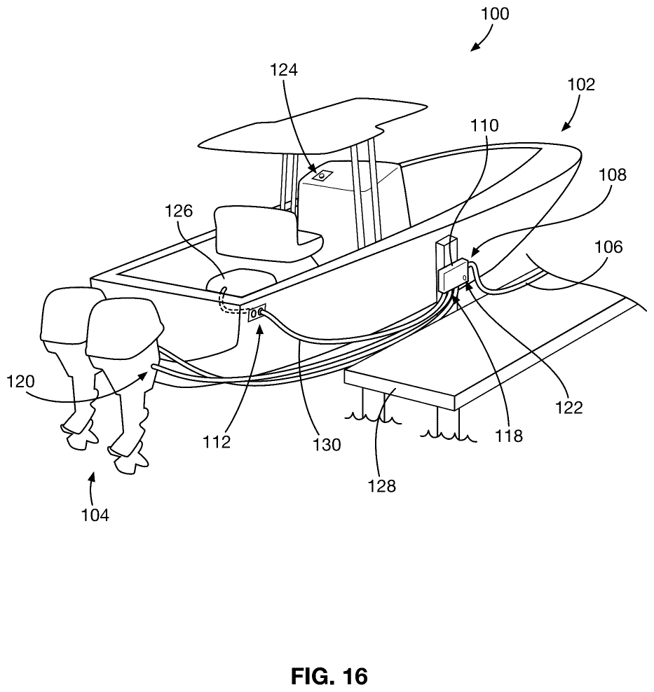

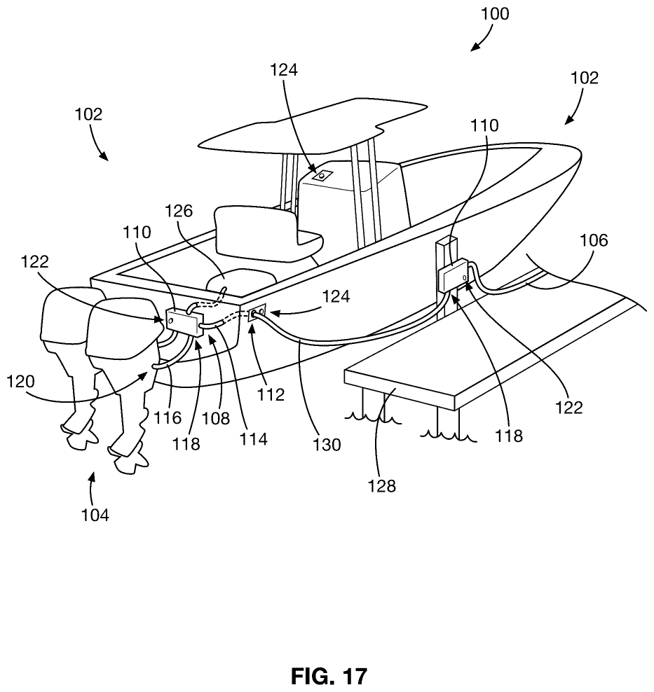

Referring now to FIGS. 16-17, the boat 100 is shown with the flushing system 102 attached to a dock 128 at which the boat 100 is docked. Attaching the flushing system 102 to the dock 128 allows the flushing system 102 to be operated from the dock 128 and allows boats without an onboard flushing system 102 to have their seawater-based systems be flushed with fresh water when docked. Mounting the flushing system 102 on the dock 128 also allows the distribution manifold 110 to remain connected to a fresh water source via the supply hose 106 that is connected to the inlet port 108 of the dockside distribution manifold 110.

Referring now to FIG. 16, the flushing system 102 is shown attached to the dock 128 and to a boat 100 that does not include a flushing system 102. In this arrangement, the supply hose 106 is connected to the dock-mounted or dockside distribution manifold 110 to provide fresh water to the flushing system 102. To provide fresh water to the boat 100, a dockside hose 130 is connected from one of the outlet ports 118 of the dock-mounted distribution manifold 110 to the inlet port 108, the remote inlet port 112, or to one or both of the motor flushing ports 120 of the boat 100. Once the dockside hoses 130 are attached to the boat 100, the flushing process can be initiated from the dock 128 by actuating the button or switch 122 arranged on the dockside distribution manifold 110. After flushing each of the connected systems of the boat 100 with fresh water, the dockside hoses 130 can be disconnected. In some implementations, the dockside hoses can be attached to the inlet ports 108, the remote inlet ports 112, or to one or both of the motor flushing ports 120 of additional boats 100 so that multiple boats can be flushed at the same time.

Boats 100 equipped with an onboard flushing system 102 can also connect to a dockside flushing system 102, as is shown in FIG. 17. When a boat 100 that includes an onboard flushing system 102 is connected to the dockside flushing system 102, the dockside hose 130 can be connected to the inlet port 108 or remote inlet port 112 of the onboard flushing system 102. Activating the flushing systems 102 can be done by the switch or button 122 on the dockside distribution manifold 110, or by a remote switch, or by an app on the user's smartphone, tablet, or other device. Upon activation, the dockside flushing system 102 allows fresh water to flow from the supply hose 106, through the dockside manifold 110, the outlet port 118 of the dockside manifold 110, the dockside hose 130, and into the onboard flushing system 102, where the fresh water can be distributed to each motor 104 and any other connected system or component 126. The onboard flushing system 102 can be activated to distribute fresh water by manually actuating the switch or button 122 on the onboard distribution manifold 110, or remotely via the remote switch 124, or via communication from the dockside flushing system 102. For example, in some implementations, actuation of the switch 122 on the dockside distribution manifold 110 activates the dockside flushing system 102 and also sends a wireless signal to the onboard flushing system 102 to cause the onboard distribution manifold 110 to be activated, thereby delivering fresh water to each connected system.

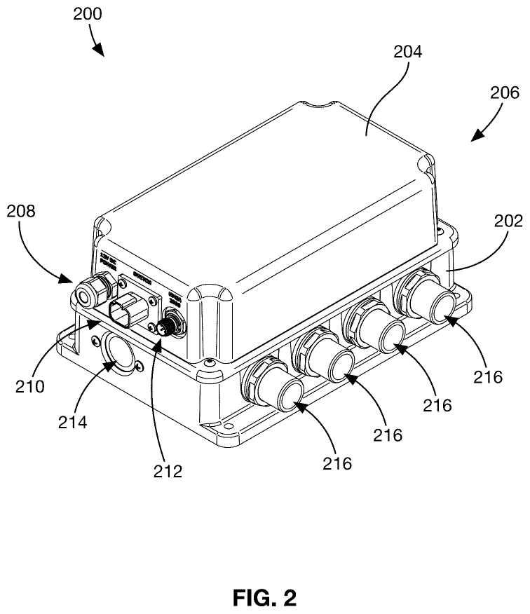

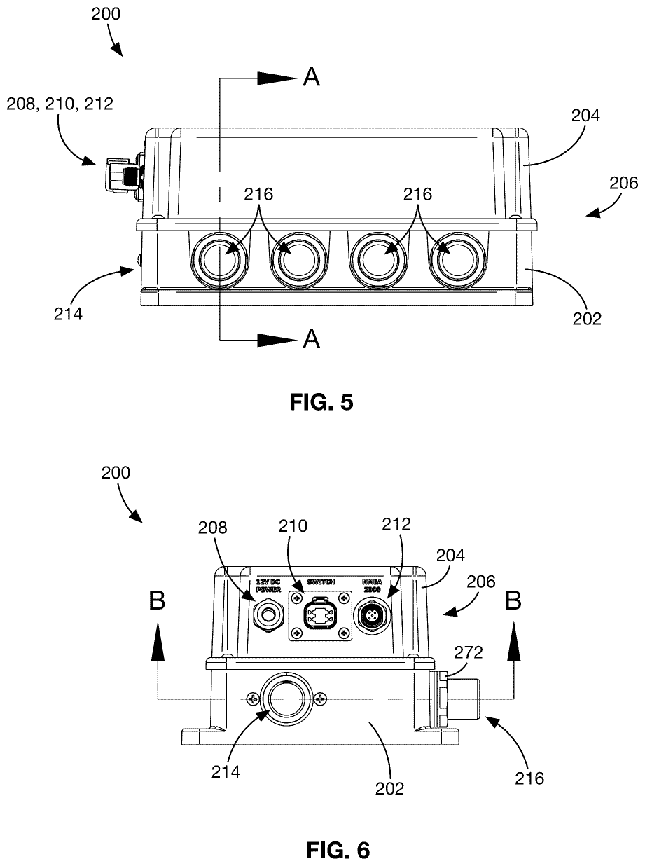

Referring now to FIGS. 2-10, an exemplary flushing system 200 is illustrated. The flushing system 200 includes a base 202 and a cover 204 that is removably attached to the base 202. The cover 204 and the base 202 form a water-tight enclosure or housing 206 to house internal components of the flushing system 200 so that, for example, electronic controls are protected from damage that can come from exposure to the elements. Like the flushing system 102 described above, the flushing system 200 can be installed outboard or inboard of a hull of a boat, such as the boat 100 of FIG. 1, and can be connected to other flushing systems 200 as desired.

The cover 204 includes a power interface 208 for providing power to the flushing system 200, a switch interface 210 for connecting the flushing system 200 to a remote switch (such as the remote switch 124 described above), and a data interface 212 for electronically connecting the flushing system 200 to a remote control system (not shown) for monitoring and controlling other systems of the boat, including additional flushing systems 200. The power interface 208, the switch interface 210, and the data interface 212 are formed from water-tight electrical connectors to prohibit water damage and/or the interruption of electrical signals by water corroding or otherwise damaging the conductive elements of the power interface 208, the switch interface 210, and the data interface 212.

The base 202 includes an inlet port 214 for connecting the flushing system 200 to a fresh water supply from a supply hose 106 or an inlet hose 114 from a remote inlet port 112, as is described above. The inlet port 214 can be any connector suitable for providing a fluid connection between the supply hose 106 and the flushing system 200, such as, for example, a threaded connector, a quarter-turn connector, a quick-disconnect connector, or the like and can be a male or female connector. The base 202 also includes one or more outlet ports 216 for connecting the flushing system 200 to one or more outlet hoses 116 to provide fresh water from the water supply to the one or more flushing ports 120 of the one or more marine motors 104. Like the inlet port 214, the one or more outlet ports 216 can be any connector suitable for providing a fluid connection between the flushing system 200 and the one or more outlet hoses 116, such as, for example, a threaded connector, a quarter-turn connector, a quick-disconnect connector, or the like and can be a male or female connector.

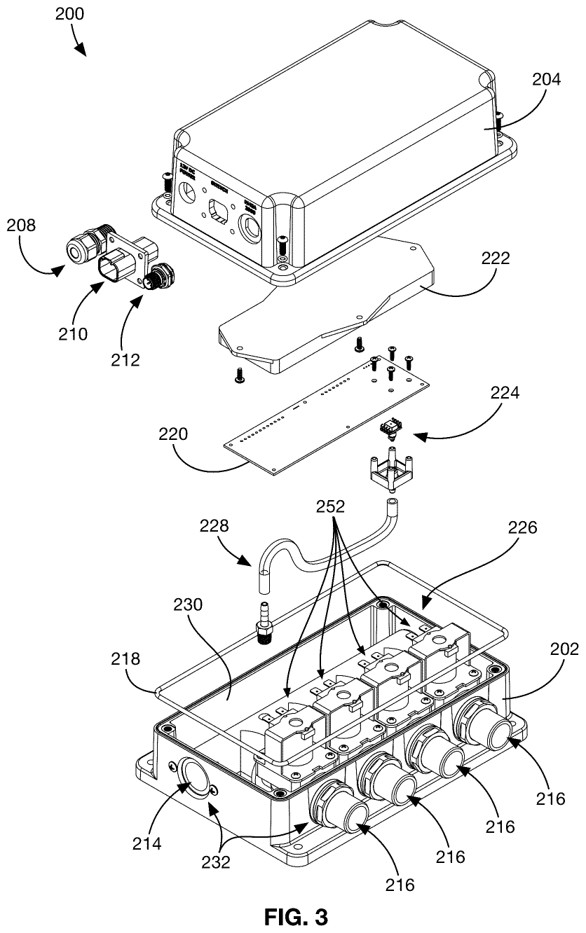

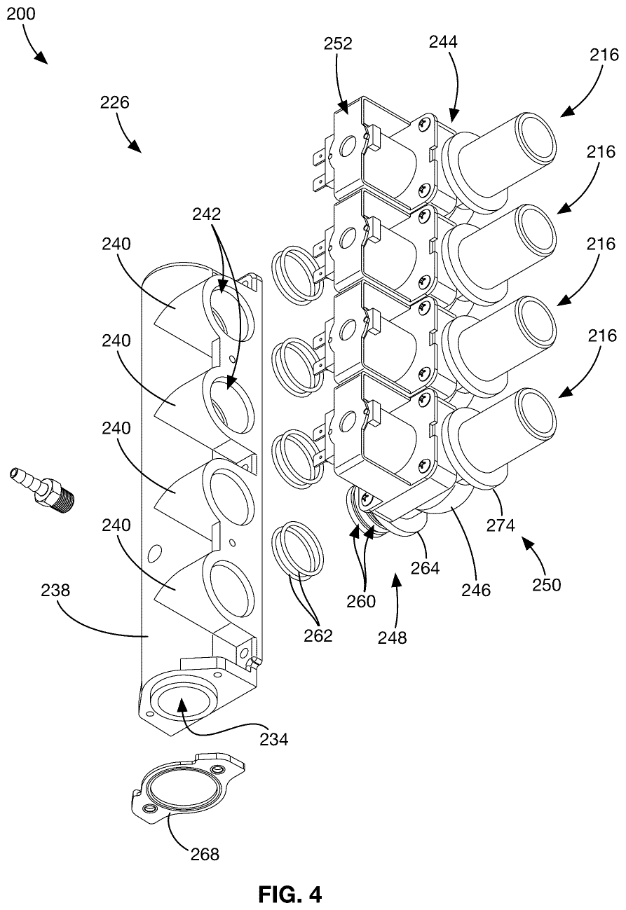

Referring now to FIGS. 3 and 4, exploded views of the flushing system 200 are shown. A gasket or seal 218 is provided between the base 202 and the cover 204 so that when the cover 204 is attached to the base 202, the gasket 218 provides a water-tight seal between the base 202 and the cover 204 to form the enclosure 206. The cover 204 can be secured to the base 202 by any suitable structure, for example, a plurality of fasteners, clamps, latches, or the like. Gaskets, O-rings, or the like (not shown) are also provided between the cover 204 and the power interface 208, the switch interface 210, and the data interface 212 to prohibit water ingress through the cover 204.

A controller 220 is mounted in a controller housing 222 and can optionally be covered with potting material to protect the controller 220 from water damage. The controller housing 222 is attached to the cover 204 with fasteners, adhesives, or any other suitable means of attaching the controller housing 222 to the cover 204. Alternatively, the controller housing 222 can be integrally formed with the cover 204. The controller 220 can optionally include a pressure sensor 224 for monitoring the pressure of water provided at the inlet port 214 from the supply hose 106. The pressure sensor 224 can be connected to a flow manifold 226 via a pressure tap 228. Alternatively, the pressure sensor 224 can be mounted directly on the flow manifold 226 and be connected to the controller 220 via a wire. An exemplary pressure sensor 224 can be any suitable sensor or transducer capable of detecting and measuring the pressure of the water provided to the flushing system 200 via the inlet port 214.

The base 202 includes an outer wall 230 that includes openings 232 through which the inlet port 214 and the one or more outlet ports 216 extend to provide hose connections. The base 202 can be formed with two openings 232 drilled or machined out to accommodate two outlet ports 216 with locations for openings 232 for third and fourth outlet ports 216 remaining solid unless they are machined or drilled open to accommodate additional outlet ports 216. Forming the base 202 with only two openings 232 for outlet ports 216 by default simplifies the manufacturing process and reduces the number of parts that need to be stored in inventory because a single base 202 can be used for flushing systems 200 having two, three, and four outlet ports 216.

The inlet port 214 and the outlet ports 216 are fluidly connected via the flow manifold 226 arranged within the outer wall 230 of the base 202. The flow manifold 226 can be formed separately from and be attached to the base 202 or can be integrally formed with the base 202. The flow manifold 226 includes an inlet channel 234 that is in fluid communication with the inlet port 214 and one or more outlet channels 236 that are in fluid communication with the one or more outlet ports 216. The optional pressure tap 228 fluidly connects the inlet channel 234 to the pressure sensor 224 so that the pressure sensor 224 can generate a pressure signal and transmit the pressure signal to the controller 220.

Referring now to FIG. 4, an exploded view of the flow manifold 226 is shown. The flow manifold 226 includes a main body 238 that encloses the inlet channel 234 and four outlet bodies 240 arranged on one or both sides of the main body 238. Two, three, or four of the outlet bodies 240 of the flow manifold 226 can include outlet interfaces 242 for connecting the flow manifold 226 to two, three, or four outlet valves 244. The flow manifold 226 can also include only one outlet interface 242 to connect to only one outlet valve 244. The flow manifold 226 can be manufactured with only two outlet interfaces 242 formed in the outlet bodies 240. When a flushing system 200 is needed that has three or four outlet ports 216, additional outlet interfaces 242 can be machined into the outlet bodies 240 that were formed without an outlet interface 242. If only a single outlet valve 244 is desired, the remaining outlet interface 242 can be plugged or otherwise sealed shut. Forming flow manifolds 226 with only two outlet interfaces 242 by default simplifies the manufacturing process and reduces the number of parts that need to be stored in inventory because a single flow manifold 226 can be used for flushing systems 200 having one, two, three, and four outlet ports 216.

One of the outlet valves 244 is connected between each of the outlet interfaces 242 and the outlet ports 216. Each outlet valve 244 includes a valve body 246 that has a valve inlet 248 and a valve outlet 250. The outlet channel 236 extends from the inlet channel 234, through the outlet interface 242 and outlet valve 244 to the outlet port 216. When one of the outlet valves 244 is in an open condition, water is permitted to flow from the inlet port 214 to the outlet port 216 connected to the open outlet valve 244. Each of the outlet valves 244 are opened and closed by an actuator or solenoid 252 mounted to the valve body 246. The actuators 252 are connected by wires (not shown) to the controller 220 and are actuated between a closed condition and an open condition as determined by the controller 220.

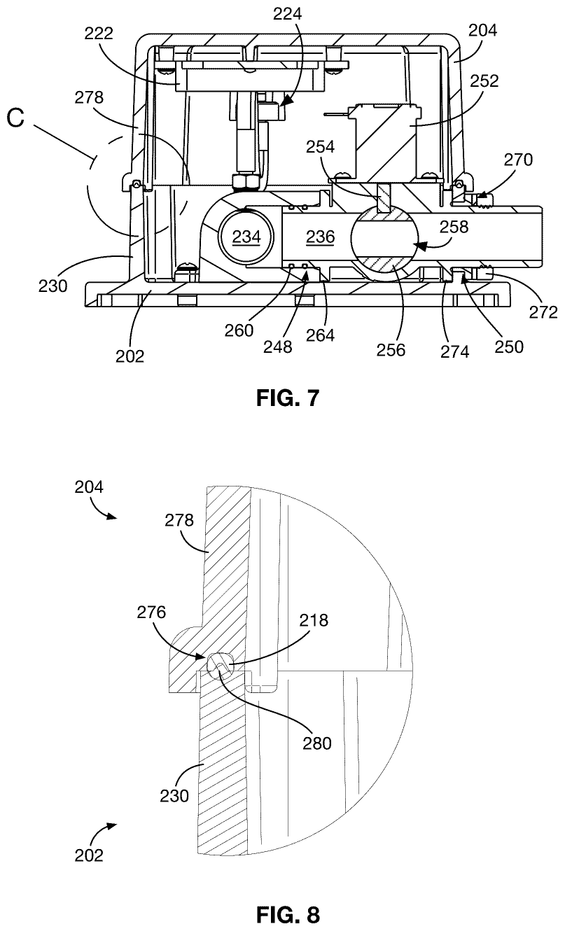

Each actuator 252 is secured to a stem 254 (FIG. 7) of one of the outlet valves 244 so that actuation of the actuator 252 causes the stem 254 to rotate and rotate a ball 256 of the valve 244 in turn. The valve ball 256 includes an orifice 258 through which water can flow when the ball 256 is oriented so that the orifice 258 is aligned with the outlet channel 236. When the ball 256 is positioned so that the orifice 258 is transverse to the outlet channel 236, flow through the outlet valve 244 is prohibited. In an exemplary flushing system 200, the valve ball 256 can be rotated so that the orifice 258 partially aligns with the outlet channel 236 so that water is allowed to flow through the outlet valve 244 but at a flow rate that is less than when the orifice 258 is fully aligned with the outlet channel 236. Keeping the outlet valve 244 partially open also reduces the pressure of the water at the outlet port 216 of the flushing system 200. In an exemplary flushing system 200, the controller 220 can also pulse the actuation of the actuator 252 so that the ball 256 rotates back and forth quickly to clear contaminates from the outlet channel 236 that can disrupt the function of the flushing system 200.

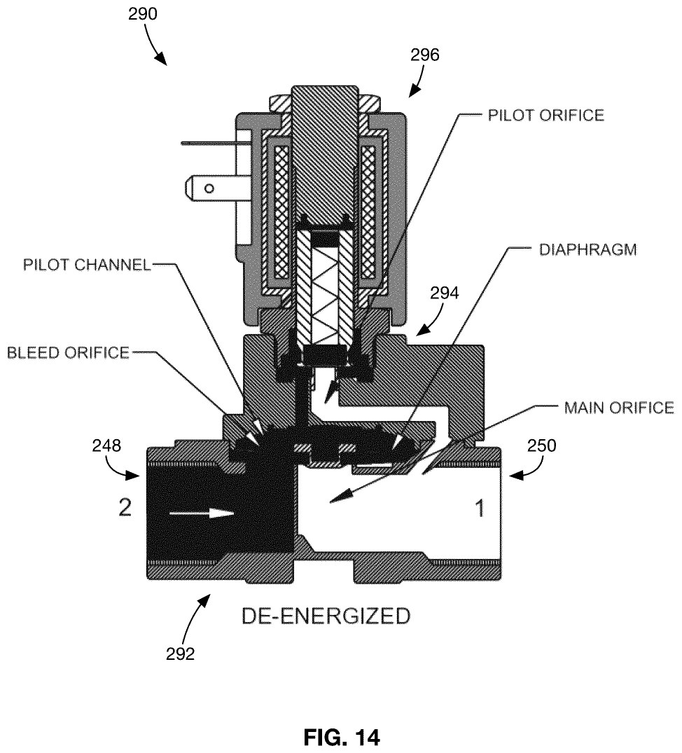

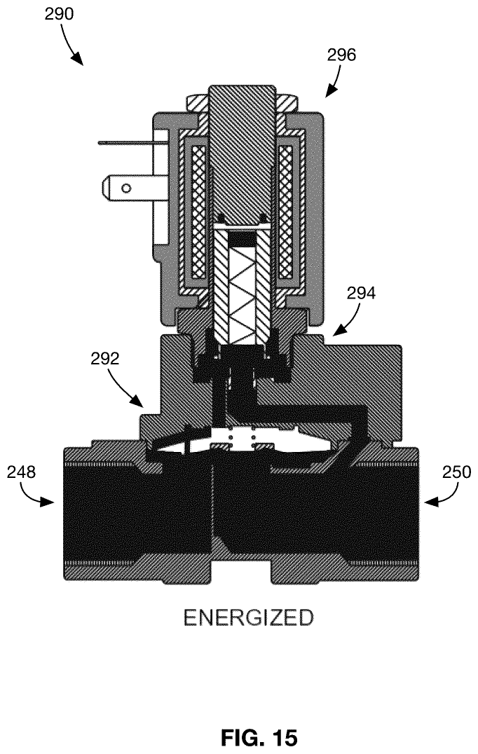

Referring now to FIGS. 14-15, cross-section views of pilot-operated outlet valves 290 are shown that are pilot-operated diaphragm valves. The outlet valves 290 have a diaphragm valve 292 that can be opened and closed to allow water to pass through the valve 290 from the valve inlet 248 to the valve outlet 250. The diaphragm valve 292 is opened and closed by a pilot valve 294 that is actuated by a solenoid 296. When the solenoid 296 is de-energized, water pressure at the valve inlet 248 presses against an inlet side of a diaphragm of the diaphragm valve 292 to keep the diaphragm valve 292 closed. When the solenoid 296 is energized or actuated to open the pilot valve 294, water from the valve inlet 248 is allowed to flow to the valve outlet 296 via a pilot channel to equalize the pressure on both sides of the diaphragm so that the diaphragm valve 292 is opened and water is allowed to flow through the valve 290. Because the diaphragm valve 292 is actuated via a pressure differential generated by the fluid flowing through the valve 290, a relatively small pilot valve 294 and solenoid 296 can be used to operate a diaphragm valve 292 with a larger orifice, thereby increasing flow through the valve 290 relative to other valves with a similarly-sized actuation mechanism. The outlet valves 290 can be controlled in a similar manner to the outlet valves 244 described herein. For example, the solenoid 296 can be rapidly actuated to open and close the pilot valve 294, thereby rapidly opening and closing the diaphragm valve 292 to clear debris that may be stuck inside the valve 290.

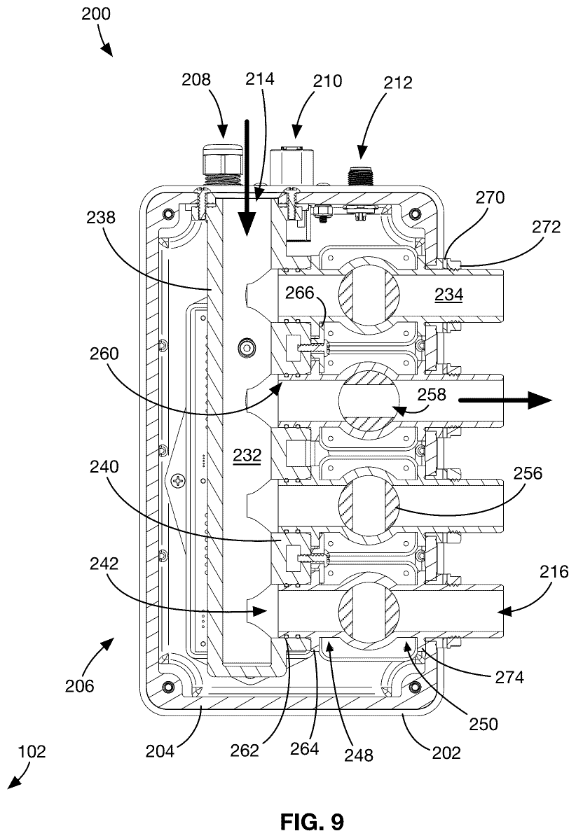

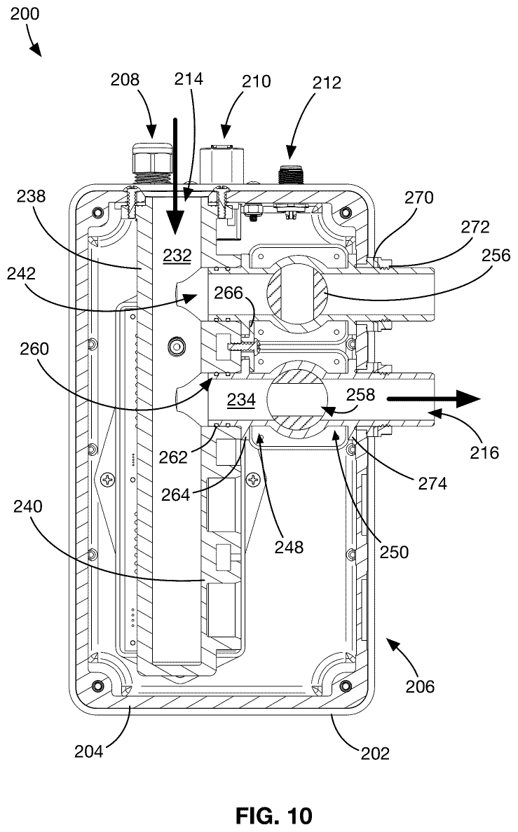

The valve inlets 248 have a cylindrical shape and include one or more O-ring grooves 260 for receiving one or more O-ring seals 262 that form a water-tight seal between the valve inlet 248 and the corresponding outlet interface 242. The exemplary flow manifold 226 illustrated in FIG. 4 includes two O-ring grooves 260 and two O-ring seals 262 on each valve inlet 248 so that leaks are prohibited even if one of the two O-ring seals 262 is compromised and allows water to leak into the flushing system 200. The valve inlets 248 each include an inlet flange 264 that is retained against the outlet bodies 240 of the flow manifold 226 by retaining clips 266, as can be seen in the cross-sectional view shown in FIGS. 7-8. The retaining clips 266 can be secured to the outlet bodies 240 via threaded fasteners as shown in FIGS. 9-10, or any other suitable fastening means.

When the flow manifold 226 is assembled with the base 202 of the flushing system 200, the main body 238 is sealed against the outer wall 230 of the base 202 by an inlet seal or gasket 268. Similarly, the valve outlets 250 of each of the outlet valves 244 are sealed against the outer wall 230 of the base 202 by outlet seals or gaskets 270 secured against the base 202 by, for example, outlet nuts 272 that can be threaded onto the outlet ports 216. Tightening the outlet nuts 272 against the outlet gaskets 270 pulls outlet flanges 274 of the outlet valves 244 against the inside of the outer wall 230 of the base 202 to further secure the flow manifold 226 to the base 202.

The inlet gasket 268 and the outlet gaskets 270 form water-tight seals at the interface between the base 202 and the inlet port 214 and the outlet ports 216 to prohibit water outside the flushing system 200 from getting inside the flushing system 200 while the O-ring seals 262 prohibit leaks from the inlet channel 234 and outlet channel 236 into the interior of the flushing system 200. As was described above, a water-tight seal is formed between the cover 202 and the base 204 by the gasket 218. As can be seen in FIGS. 7-8, the gasket 218 is arranged in a groove 276 formed in an outer wall 278 of the cover 204. A raised lip 280 formed in the outer wall 230 of the base 202 can optionally be included to apply pressure to the gasket 218 when the cover 204 is secured to the base 202. Alternatively, the groove 276 for the gasket 218 can be formed in the base 202 and the raised lip 280 can be formed in the cover 204.

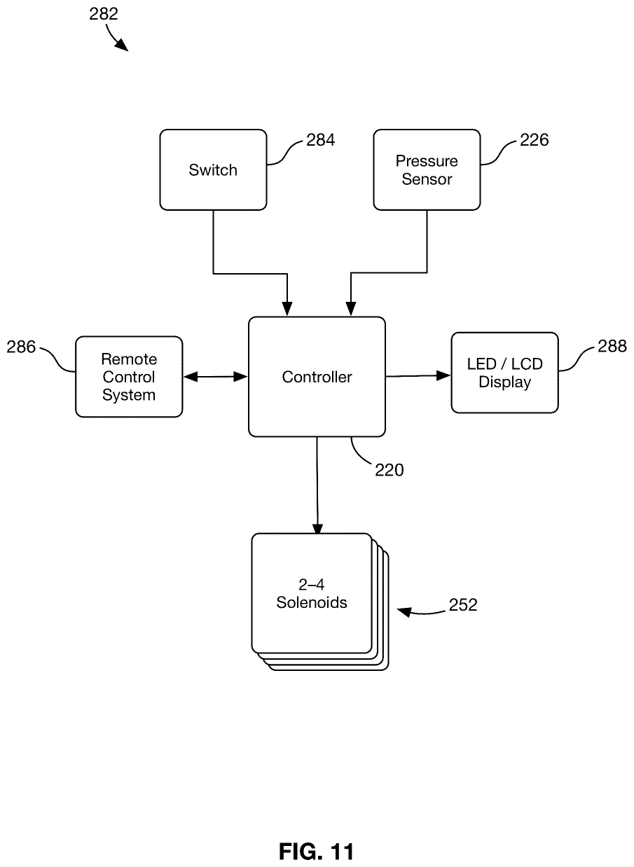

Referring now to FIG. 11, a block diagram of a control system 282 for an exemplary flushing system 200 is illustrated. The control system 282 includes the controller 220 that receives signals from a switch 284 and from the optional pressure sensor 224. The switch 284 can be installed on the flushing system 200, such as on the cover 204 or base 202, or can be installed elsewhere on the boat 100 and be connected to the flushing system 200 via a wire that attaches to the switch interface 210. Alternatively, the switch 284 can communicate remotely with the controller 220 via a wireless connection or through remote control system 286 connected to the flushing system 200 via the data interface 212.

Water pressure data provided to the controller 220 by the optional pressure sensor 224 can be used by the controller 220 to detect potential issues in the flushing system 200 and change the operation of the flushing system 200 and/or notify the user of the flushing system 200 in response. For example, in an exemplary flushing system 200, the controller 220 prohibits the flushing system 200 from operating when the water pressure measured by optional pressure sensor 224 is below a predetermined threshold or when no pressure is detected—e.g., when a water source is not connected to the inlet port 214. The controller 220 can optionally notify the user that the pressure at the inlet port 214 is low or non-existent, as is described in greater detail below. Monitoring the water pressure can also enable the controller 220 to identify when an outlet valve 244 is stuck—i.e., when the controller 220 attempts to actuate one of the outlet valves 244 and no drop in pressure is detected by the opening of the outlet valve 244, the controller 220 can notify the user that the outlet valve 244 might be stuck closed. Conversely, if no increase in pressure is detected after actuating one of the outlet valves 244, the controller 220 can notify the user that the outlet valve 244 might be stuck open.

Pressing the switch 284 to activate the flushing system 200 can also communicate to the controller 220 a desired cycle time for a flushing cycle. For example, a single press of the switch 284 can indicate that the flushing cycle should take 15 minutes. Activating the switch 284 twice can indicate to the controller that a different cycle time should be applied, such as, for example, a 7.5 minute cycle time. Any suitable cycle time can be programmed into the controller 220, such as, for example, a cycle time specified by the manufacturer of the motor 104 or additional system or component 126. Different flushing profiles for motors 104 made by different manufacturers and additional systems 126 can be stored in the controller 220 so that the flushing system 200 can adjust the cycle time and pressure requirements when the flushing system 200 is attached to different motor models or other components of the boat. In an exemplary flushing system 200, the cycle time is adjusted based on the pressure of the water supplied at the inlet port 214 as measured by the pressure sensor 224. That is, when water is supplied at higher pressure, the volumetric flow rate is greater so that less time is needed to flush the same volume of water through an attached motor or other device. In other words, the controller 220 can reduce the cycle time for higher water pressures and extend the cycle time for lower water pressures.

The flushing system 200 can also be placed in a maintenance mode wherein a flushing operation is allowed continue until manually stopped. While maintenance mode is active, pressing the switch 284 can cause the flushing system 200 to switch between outlet valves 244 to flush water through different motors connected to the flushing system 200. Additionally, the outlet valves 244 can be controlled by the controller 220 via a pulsed control signal to rapidly rotate the ball of the valves 244 back and forth to clear any potential debris that may have accumulated on the valve ball 256, orifice 258, and/or the outlet channel 236.

The controller 220 includes memory for storing program data for operating the flushing system 200 and for storing an event log recording the events that occur during the operation of the flushing system 200. For example, the memory can record the serial number of the flushing system 200, the last time the flushing system 200 was operated, the time remaining in the current flushing operation, the number of operational outlet valves 244, the historical and current pressure detected by the pressure sensor 224, errors in the operation of the flushing system 200 and any associated error codes, and the like. Recording the usage history of the flushing system 200 can also be reported to a motor manufacturer to ensure that the motor was maintained according to the manufacturer's requirements to uphold the manufacturer's warranty. As was noted above, the control system 220 can also include different flushing profiles for motors 104 made by different manufacturers so that the flushing system 200 can tailor the flushing operation to the particular motor 104 attached to the outlet port 216. The data recorded by the control system 220 can include the flushing profile used to flush the motor 104 so that the manufacturer can confirm that the proper flushing profile was used when flushing the motor 104.

The remote control system 286 can be control system that interfaces with the other components of the boat 100, such as, for example, a host device connected to the controller 220 and other components via a 2-wire differential bus serial network conforming to the NMEA standard, e.g., NMEA 2000. The controller 220 and remote control system 286 can also connect to each other wirelessly, such as, for example, a 2.45 GHz band network, a Bluetooth connection, a WIFI network, or the like.

A wide variety of other events can be recorded by the controller 220 for communicating to the user via, for example, the remote control system 286 or an optional LED light or LCD display 288 that are included to provide feedback to the user. The optional LED light or LCD display 288 can provide feedback to the user, for example, to show the user that the flushing system 200 is active. The flushing system 200 can include a plurality of LEDs, for example, one for each outlet valve 244 that are operated to indicate which of the outlet valves 244 is open or closed. The status of the flushing system 200 can also be reported by the controller 220 to an application running on a user's computing device, such as, for example, a smart phone, a tablet, or a personal computer.

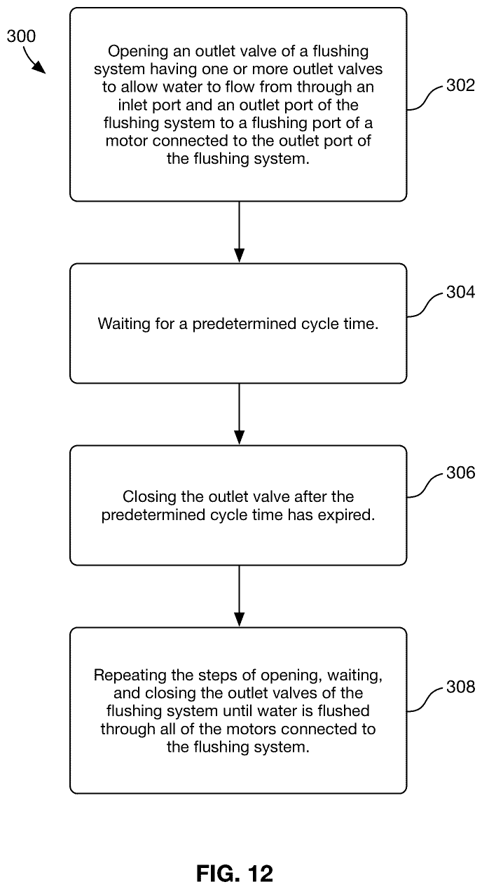

Referring again to FIG. 12, a methodology 300 of operating an exemplary flushing system 200 is illustrated. The methodology 300 begins at 302 by opening an outlet valve of a flushing system having one or more outlet valves to allow water to flow from through an inlet port and an outlet port of the flushing system to a flushing port of a motor connected to the outlet port of the flushing system. Waiting for a predetermined cycle time at 304 and closing the outlet valve after the predetermined cycle time has expired at 306. The steps of opening, waiting, and closing are repeated at 308 for each of the outlet valves of the flushing system until water is flushed through all of the motors connected to the flushing system. The methodology 300 can be performed using any of the flushing systems described herein.

Optionally, a step of comparing an inlet pressure measured by a pressure sensor to a threshold pressure before opening the outlet valve to confirm whether the supplied water meets a minimum pressure required to operate the flushing system. If the minimum pressure is not met, an additional step of notifying the user of the deficient pressure can be performed. In an exemplary flushing system, a maintenance mode of the flushing system can be activated wherein the step of waiting includes waiting for a user to indicate that the flushing operation should be ceased and another outlet valve opened.

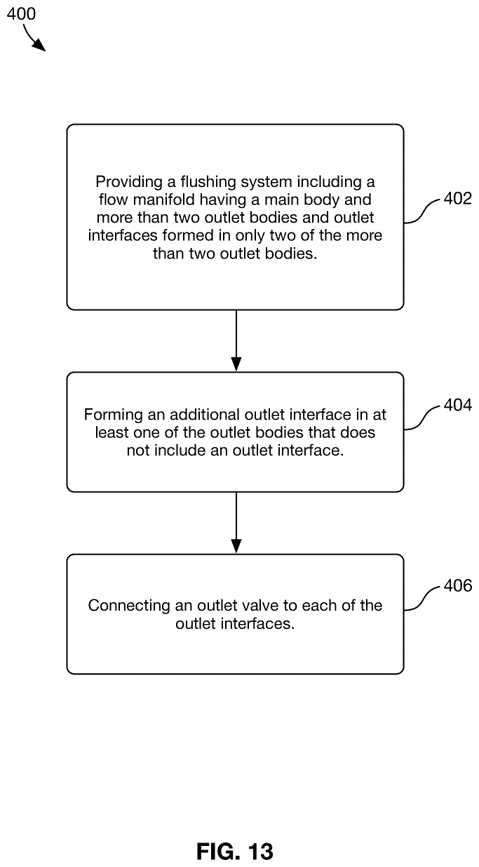

Referring now to FIG. 13, a methodology 400 that facilitates the making of a flushing system such as the flushing systems 102, 200 described herein. The methodology 400 begins at 402 by providing a flow manifold 226 that includes a main body 238 and more than two outlet bodies 240. At least one outlet body 240 does not include an outlet interface 242 for connecting with an outlet valve 244. One or more outlet interfaces 242 are formed in an outlet body 240 that does not include an outlet interface 242 at 404. After the outlet interfaces 242 are formed in the outlet bodies 240, an outlet valve 244 is connected to each of the outlet interfaces 242 at 406. In an exemplary flushing system 200, the flow manifold 226 includes two outlet interfaces 242 formed in four outlet bodies 240. Third and fourth outlet interfaces 242 are formed in the two outlet bodies 240 that do not include an outlet interface 242 via drilling or machining operations. An exemplary flushing system 200 can also include a base 202 having two openings 232 to accommodate outlet ports 216 that provides space for two additional openings 232 to be formed in the base 202 to accommodate additional outlet ports 216. That is, the flow manifold 226 can be expanded from two to four connections and the outer wall 232 of the base 202 can expanded correspondingly. The methodology 400 can be performed to manufacture any of the flushing systems described herein.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

While various aspects, features and concepts may be expressly identified herein as being inventive or forming part of a disclosure, such identification is not intended to be exclusive, but rather there may be inventive aspects, concepts, and features that are fully described herein without being expressly identified as such or as part of a specific disclosure, the disclosures instead being set forth in the appended claims. Descriptions of exemplary methods or processes are not limited to inclusion of all steps as being required in all cases, nor is the order that the steps are presented to be construed as required or necessary unless expressly so stated. The words used in the claims have their full ordinary meanings and are not limited in any way by the description of the embodiments in the specification.

What is claimed:

1. A flushing system comprising:
an inlet port;
an inlet channel in fluid communication with the inlet port, the inlet channel being formed by a main body of a flow manifold;
a plurality of outlet channels in fluid communication with the inlet channel and a plurality of outlet valves, wherein each outlet valve comprises a valve inlet that is connected to an outlet interface of the main body of the flow manifold, and wherein the valve inlet comprises a plurality of O-ring seals for forming a water-tight connection between the valve inlet and the outlet interface;
a plurality of outlet ports, each outlet port in fluid communication with one of the plurality of outlet valves;
an actuator attached to each of the plurality of outlet valves; and
a controller configured to control each of the actuators to actuate each of the outlet valves to permit water to flow from the inlet port to each of the outlet ports.

2. The flushing system of claim 1, further comprising a pressure sensor in fluid communication with the inlet channel.

3. The flushing system of claim 1, further comprising an activation switch for initiating a flushing cycle of the flushing system.

4. The flushing system of claim 3, wherein the activation switch is a remote activation switch.

5. The flushing system of claim 1, wherein the outlet valves are actuated by a pilot valve.

6. The flushing system of claim 1, wherein the outlet valves are opened and closed by a rotation of the actuator.

7. The flushing system of claim 1, further comprising a water-tight enclosure encompassing the flow manifold, controller, actuators, and outlet valves.

8. The flushing system of claim 1, wherein at least one of the outlet ports is connected to a cooling system.

9. The flushing system of claim 8, wherein the cooling system is a motor cooling system.

10. The flushing system of claim 8, wherein the outlet port is fluidly connected to the cooling system via a flushing port on an exterior of a boat hull.

11. The flushing system of claim 10, wherein the flushing system is mounted on a dock adjacent to the boat hull.

12. The flushing system of claim 1, wherein the inlet port is accessible on an exterior of a boat hull.

13. A method of operating a flushing system comprising an inlet port, two or more outlet ports, an inlet channel in fluid communication with the inlet port, two or more outlet channels in fluid communication with the inlet channel and the two or more outlet ports, and an outlet valve provided in each of the two or more outlet channels, the method comprising:
opening one of the two or more outlet valves;
waiting for a predetermined cycle time;
closing the outlet valve after the predetermined cycle time has expired; and
repeating the steps of opening, waiting, and closing for each of the two or more outlet valves.

14. The method of claim 13, wherein the flushing system further comprises a remote switch and the steps of opening, closing, and repeating are initiated manually in response to the remote switch.

15. The method of claim 13, further comprising a step of partially opening one of the two or more outlet valves.

16. The method of claim 13, wherein the flushing system further comprises a pressure sensor in fluid communication with the inlet channel, and the method further comprises a step of comparing an inlet pressure measured by the pressure sensor to a predetermined threshold pressure.

17. The method of claim 16, further comprising a step of notifying a user when the inlet pressure does not meet the predetermined threshold.

18. The method of claim 13, wherein the flushing system further comprises a controller configured to actuate the two or more outlet valves, and the method further comprises a step of sending a pulsed control signal to one of the two or more outlet valves.

19. The method of claim 13, wherein a first outlet port of the flushing system is in fluid communication with a motor and a second outlet port of the flushing system is in fluid communication with one of a motor, a seakeeping system, and a marine air conditioning system.

20. The method of claim 19, wherein the predetermined cycle time is different for the outlet valve connected to the first outlet port and the outlet valve connected to the second outlet port.
